(19) United States
(12) Patent Application Publication
(10) Pub. No.: US 2004/0200512 A1
(43) Pub. Date: Oct. 14, 2004

(54) Fill control for appliance

(76) Inventors: Michael T. Clouser, Brownsburg, IN (US); Michael R. DuHack, Indianapolis, IN (US)

Correspondence Address: HARNESS, DICKEY & PIERCE, P.L.C., P.O. BOX 828, BLOOMFIELD HILLS, MI, 48303, US

(21) Appl. No.: 10/413,114

(22) Filed: Apr. 14, 2003

(51) Int. Cl. B08B 3/02

(52) U.S. Cl. 134/57 D; 134/58 D; 134/103.3; 134/113

(57) ABSTRACT

A control system for monitoring the filling of a washing appliance with liquid. The control system energizes a fault indicator when a no-fill and/or an overfill condition occurs. Specifically, when a no-fill condition occurs at a time when the washing appliance should have a predetermined liquid level therein, the control system energizes a fault indicator and suspends operation so that damage to the washing appliance is prevented and/or minimized. When an overfill condition (i.e., a liquid level above a predetermined level) occurs the control system energizes a fault indicator and suspends operation to prevent and/or minimize damage to the washing appliance and/or the surrounding environment.

### FIELD OF THE INVENTION

The present invention relates generally to automatic washing appliances such as dishwashers, and more specifically to a control system which protects against a no-fill and/or an overfill condition in the washing appliance.

### BACKGROUND OF THE INVENTION

Automatic washing appliances, such as dishwashers, have an automated control system that fills the appliance with the desired liquid and operates the appliance to perform its intended function. These automatic washing appliances depend upon the liquid being supplied at the appropriate time and in the appropriate quantities. Failure to receive the liquid at the appropriate time or in the required quantity can damage the washing appliance. For example, a pump within the washing appliance is typically utilized to route the liquid throughout the appliance at the appropriate rate and pressure to help perform the washing operation. If the washing appliance is not filled to the required level with the liquid, and operation of the washing appliance proceeds as normal, the lack of liquid can cause the pump to cavitate and/or run in a dry condition. Cavitation and/or running in a dry condition can damage the pump and/or motor that operates the pump.

Therefore, it would be desirable to provide a control system that recognizes when the washing appliance has a no-fill or an insufficient fill of liquid and ceases the operation of the appliance to avoid damage. It is also advantageous to provide an operator of the washing appliance with a fault indicator so that appropriate corrective action can be taken.

In contrast to a no-fill or insufficient full situation, an overfill situation can also damage the washing appliance. An overfill situation occurs when the liquid being supplied to the washing appliance exceeds the predetermined quantity such that more liquid is present than is required by the washing appliance. An overfill situation can tax the components of the washing appliance such that damage can result. Additionally, an overfill situation can result in liquid being in inappropriate places and/or leaking from the washing appliance such that damage to the environment external to the washing appliance (e.g., liquid leaking onto the floor) may occur.

Therefore, it would be advantageous to provide a control system that detects an overfill condition and ceases the operation of the washing appliance when an overfill condition exists to minimize and/or prevent damage to the appliance and/or environment exterior to the appliance. Furthermore, it would be advantageous to provide an operator of the washing appliance with a fault indicator when an overfill condition exists so that appropriate corrective action can be taken.

### SUMMARY OF THE INVENTION

The present invention discloses a control system that detects when a no-fill condition and/or an overfill condition occurs in the washing appliance. The control system can signal a fault condition when the no-fill or overfill condition occurs.

A control system for a washing appliance according to the present invention has a fault indicator that is operable to signal occurrence of a fault when energized. A sequence controller controls a portion of the operation of the washing appliance. The sequence controller energizes the fault indicator when a no-fill condition occurs in the washing appliance.

The present invention also discloses a method of operating a washing appliance. The method includes the steps of: (a) monitoring a liquid level in the washing appliance during a fill cycle of the washing appliance; and (b) signaling a fault condition when a no-fill condition occurs in the washing appliance.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a timing sequence diagram showing the position of various components of the control system according to the present invention at six distinct states of operation;

FIG. 2 is a schematic representation of the control system of the present invention at state 1;

FIG. 3 is a schematic representation of the control system of the present invention at state 2;

FIG. 4 is a schematic representation of the control system of the present invention at state 3;

FIG. 5A is a schematic representation of the control system of the present invention at state 4;

FIG. 5B is a schematic representation of the control system of the present invention at state 4 when a no-fill condition has occurred in the filling of the washing appliance;

FIG. 6A is a schematic representation of the control system of the present invention at state 5;

FIG. 6B is a schematic representation of the control system of the present invention at state 5 when a no-fill condition has occurred in the filling of the washing appliance;

FIG. 7 is a schematic representation of the control system of the present invention at state 6; and

FIG. 8 is a schematic representation of the control system of the present invention when an overfill condition has occurred.

### DETAILED DESCRIPTION OF THE PREFERRED EMBODIMENT

The following description of the preferred embodiment is merely exemplary in nature and is in no way intended to limit the invention, its application, or uses.

FIGS. 2-8 schematically illustrate a control system 20 according to the principles of the present invention. Control system 20 is used to control a portion of a washing cycle of a washing appliance, such as a dishwasher (not shown). Control system 20 is connected between lead line L1 and neutral line N. Control system 20 includes a level circuit 22 that monitors a liquid level in the washing appliance in which control system 20 is utilized. Level circuit 22 has a level sensor 24 that is responsive to a liquid level in the washing appliance. Level circuit 22 also has first and second level switches 26 and 28. Level switches 26 and 28 are responsive to level sensor 24 and, under certain conditions, will disrupt power to portions of control system 20, as described in more detail below. Level sensor 24 and level switches 26 and 28 can take a variety of forms as is known in the art. For example, level sensor 24 can be a mechanical float 24 and level switches 26 and 28 can be float switches 26 and 28 that are switched in response to movement of float 24, as shown in FIGS. 2-8.

First float switch 26 is a single pole, double throw switch that moves between terminals 26a and 26b. First float switch 26, depending upon the position of second float switch 28, as discussed below, completes an electrical circuit when in contact with terminal 26a (first position) and makes an open circuit when in contact with terminal 26b (second position). First float switch 26 toggles between terminals 26a and 26b as float 24 moves with the liquid level within the washing appliance. Specifically, first float switch 26 is in contact with terminal 26a when the liquid level in the washing appliance is between zero and a predetermined operating or FULL level. If the liquid level reaches or exceeds the predetermined FULL level, float 24 causes first float switch 26 to move to its second position and be in contact with terminal 26b.

Second float switch 28 is a single pole, double throw switch in line L1. Second float switch 28 moves between contact with terminals 28a and 28b which correspond, respectively, to connecting line L1 to control system 20 and disconnecting line L1 from control system 20 which also energizes a first fault indicator 30. Specifically, second float switch 28 is connected to float 24 and moves between contact with terminals 28a and 28b in response to movement of float 24 with the liquid level in the washing appliance. Second float switch 28 is in contact with terminal 28a (first position) when the liquid level in the washing appliance is between zero and a predetermined FULL level. Second float switch 28 moves to be in contact with terminal 28b (second position) when the liquid level in the washing appliance exceeds the predetermined FULL level by a predetermined amount (an overfill condition). When second float switch 28 moves from terminal 28a to terminal 28b, power to control system 20 is disrupted and routed through first fault indicator 30 so that operation of the washing appliance is suspended and an overfill condition is signaled, as described in more detail below. While second float switch 28 is preferably connected to float 24, it should be understood that second float switch 28 can be connected to a separate float (not shown) and still be within the scope of the present invention. First fault indicator 30, can take a variety of forms as will be apparent to one skilled in the art. For example, first fault indicator 30 can be a light and/or a buzzer to provide a visual and/or auditory alarm when energized by second float switch 28 being in contact with terminal 28b.

Control system 20 also has a sequence control circuit 32 that controls the sequencing of the addition of liquid to the washing appliance. Sequence control circuit 32 allows liquid to be added to the washing appliance and in conjunction with level circuit 22 provides a fault indicator when an error has occurred. Specifically, a second fault indicator 33 is energized when the washing appliance experiences a no-fill condition (i.e., fails to fill with liquid to the predetermined FULL level). Second fault indicator 33 is similar to first fault indicator 30 and can take the same form.

Sequence control circuit 32 has a sequence controller 34 and first and second sequence switches 36 and 38. Sequence controller 34 and sequence switches 36 and 38 can take a variety of forms as is known in the art. For example, sequence controller 34 can be a timer motor 34 and sequence switches 36 and 38 can be first and second timer switches 36 and 38, as shown in the FIGS. 2-8. Timer switches 36 and 38 are connected to timer motor 34 so that operation of the timer motor 34 controls the switching of first and second timer switches 36 and 38.

Timer switches 36 and 38 are single pole, double throw switches. First timer switch 36 moves between terminals 36a and 36b. First timer switch 36 is in series with first float switch 26 and second float switch 28. Thus, the ability of first timer switch 36 to energize a component of control system 20 is dependent upon the position of float switches 26 and 28.

Movement of first timer switch 36 between terminals 36a and 36b, depending upon the operating position of float switches 26 and 28, can energize a relay 40 or a liquid fill device 42, respectively. Relay 40 controls first and second pairs of contacts 44 and 46, which are normally open and normally closed contacts, respectively. Energizing relay 40 switches first and second contacts 44 and 46 to be closed and opened, respectively, which is described in more detail below. Energizing liquid fill device 42 allows a liquid to flow into the washing appliance. In the present embodiment, liquid fill device 42 is a water valve that is used to control the supplying of water to the washing appliance. Water valve 42 can take a variety of forms as will be apparent to those skilled in the art. For example, water valve 42 can be a solenoid-operated valve that allows water to flow therethrough when energized and prevents water from flowing therethrough when not energized.

The contact of first timer switch 36 with terminals 36a and 36b corresponds to respective first and second of first timer switch 36. Thus, when first and second switches 26 and 28 are in respective contact with terminals 26a and 28a, the first position of first timer switch 36 corresponds to energizing relay 40 while the second position of first timer switch 36 corresponds to energizing water valve 42.

Second timer switch 38 is controlled by timer motor 34 and switches between contact with terminals 38a and 38b which correspond to respective first and second positions of second timer switch 38. When second timer switch 38 is in contact with terminal 38a, second timer switch 38 is in series with second float switch 28 and, depending upon the operational position of second float switch 28, can energize timer motor 34. When second timer switch 38 is in contact with terminal 38b, second timer switch 38 is in series with first and second float switches 26 and 28, second fault indicator 33 and first pair of contacts 46. Depending upon the operational positions of first and second float switches 26 and 28 and energization of relay 40, second timer switch 38, when in contact with terminal 38b, energizes second fault indicator 33 and suspends operation of timer motor 34, as described in more detail below.

Control system 20 also has a sequence controller (timer motor) bypass circuit 48 that contains a second pair of contacts 46 of relay 40. Second pair of contacts 46 are in series with second float switch 28 and timer motor 34 such that, depending upon the operational position of second float switch 28 and energization of relay 40, allow timer motor 34 to be energized by timer motor bypass circuit 48, as described below.

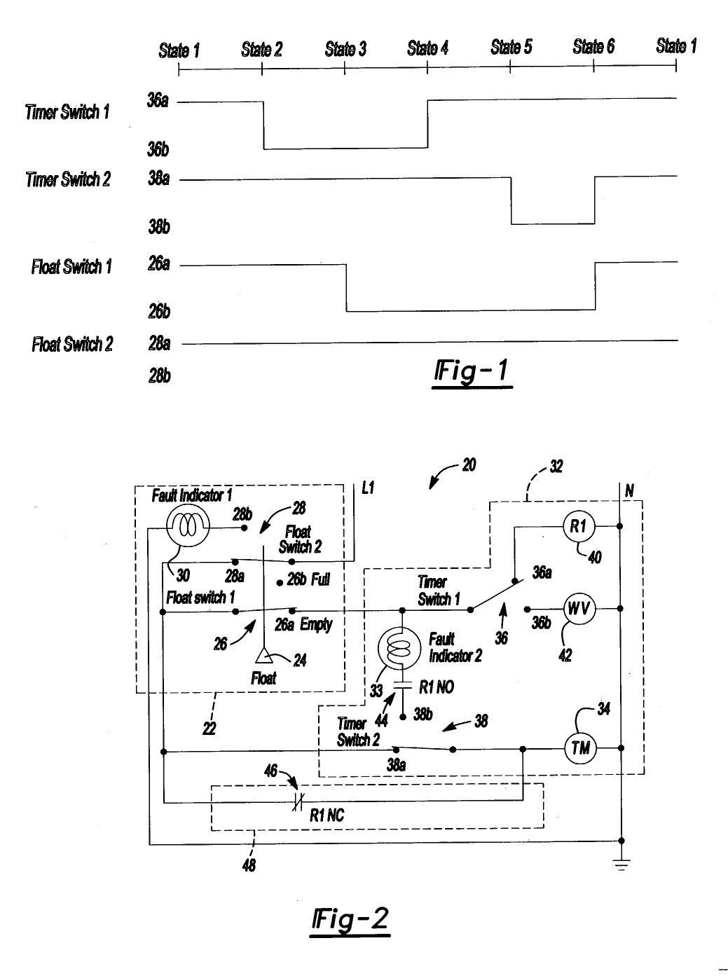

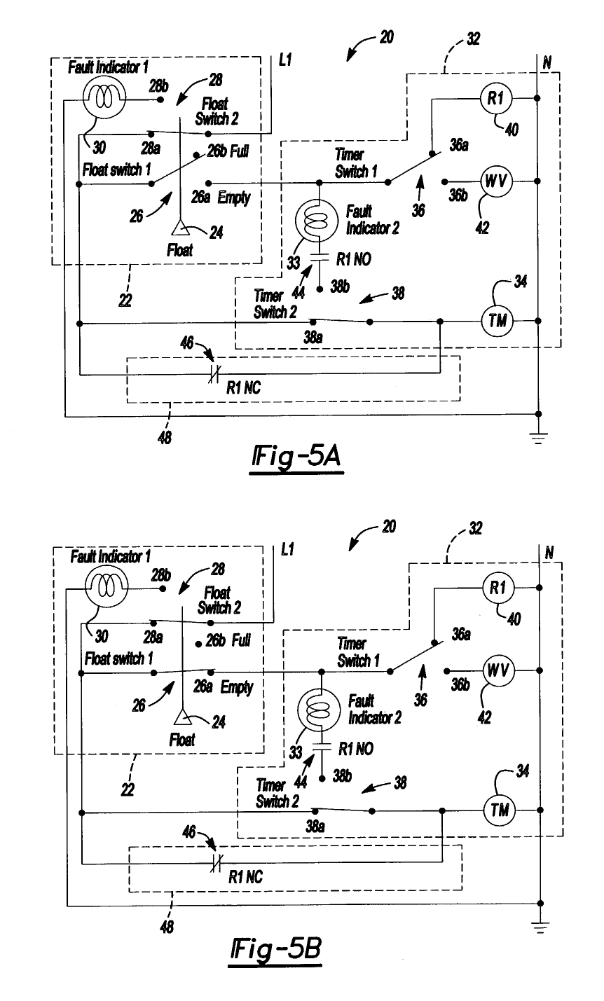

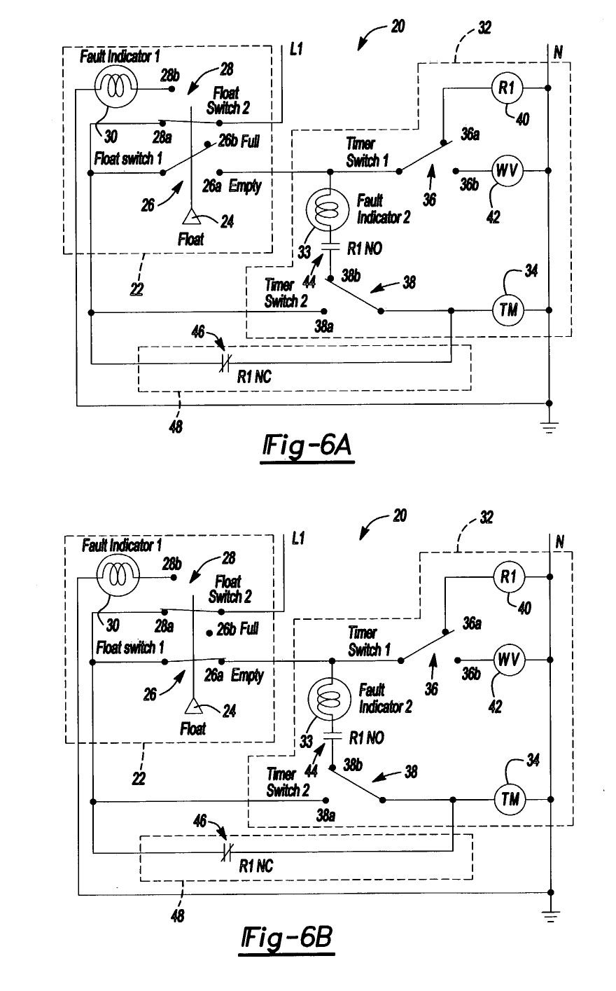

Operation of control system 20 to monitor the liquid level in the washing appliance and indicate a no-fill condition and/or an overfill condition will now be described. Referring to FIG. 1, the normal operational sequence and corresponding operational position of the various components of control system 20 are shown. Control system 20 has six operational states through which it sequences (via timer motor 34) to control the filling of the washing appliance. The operational states of the various components of control system 20 during the six states of normal operation are shown in FIGS. 2-5A, 6A, and 7. The operational states of the various components when a no-fill condition occurs are shown in FIGS. 5B and 6B. The operational states of the various components when an overfill condition occurs are shown in FIG. 8.

Referring now to FIG. 2, state 1 of the timing sequence of control system 20 is shown. State 1 corresponds to a beginning operation of the washing cycle of the washing appliance wherein the washing appliance is empty and about to receive liquid to commence the washing operation. With the washing appliance empty (or below the predetermined FULL level), first float switch 26 is in contact with terminal 26a, second float switch 28 is in contact with terminal 28a and power from line L1 can flow through control system 20. In state 1, timer motor 34 causes first timer switch 36 to be in contact with terminal 36a which energizes relay 40 and prevents energization of water valve 42. With relay 40 energized, first pair of contacts 44 are closed and second of pair of contacts 46 are open. The opening of second pair of contacts 46 prevents current from flowing to timer motor 34 through timer motor bypass circuit 48. Second timer switch 38 is in contact with terminal 38a so that timer motor 34 is provided current through second timer switch 38. The position of second timer switch 38 prevents first fault indicator 33 from being energized.

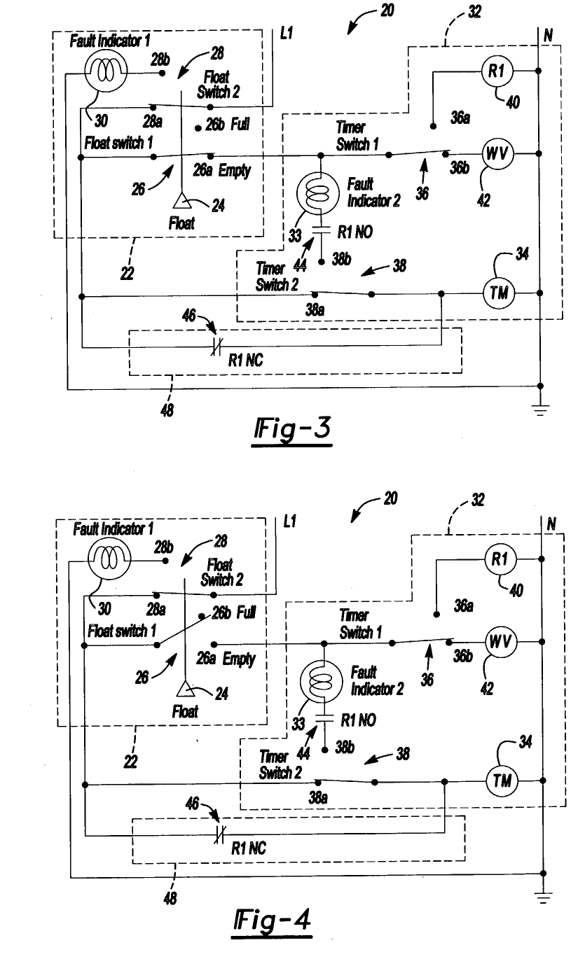

After a predetermined time interval has elapsed, as determined by timer motor 34, control system 20 moves to state 2, as shown in FIG. 3. State 2 corresponds to filling the washing appliance with liquid. To move to state 2, timer motor 34 causes first timer switch 36 to move from contact with terminal 36a to contact with terminal 36b. Float switches 26 and 28 and second timer switch 38 are unaffected. Movement of first timer switch 36 to contact with terminal 36b de-energizes relay 40 and energizes water valve 42. De-energization of relay 40 causes second pair of contacts 46 to close and allows timer motor 34 to receive power via timer motor bypass circuit 48 via the closed second pair of contacts 46 and/or through second timer switch 38. Energization of water valve 42 allows water to begin flowing into the washing appliance.

Water continues to flow into the washing appliance through water valve 42 until the liquid level rises sufficiently (i.e., rises to the predetermined FULL level) to cause float 24 to move first float switch 26 from being in contact with terminal 26a to being in contact with terminal 26b. This movement of float 24 and first float switch 26 corresponds to control system 20 moving to state 3, as shown in FIG. 4. State 3 corresponds to stopping the filling cycle when the liquid level in the washing appliance has reached the predetermined FULL level. Movement of first float switch 26 from terminal 26a to terminal 26b interrupts the power to first timer switch 36 and de-energizes water valve 42 which stops the flow of water into the washing appliance. Timer motor 34 is powered via timer motor bypass circuit 48 and/or via second timer switch 38.

After a predetermined time period, as controlled by timer motor 34, control system 20 enters state 4, as shown in FIG. 5A, regardless of the outcome of the filling cycle of state 3. The predetermined time period allows sufficient time for the washing appliance to fill to the predetermined FULL level at water flow rates and pressures that are expected to be encountered by the washing appliance.

State 4 corresponds to stopping the filling cycle if not already stopped by the washing appliance being filled up with liquid to the predetermined FULL level. Timer motor 34 causes first timer switch 36 to move from terminal 36b to terminal 36a. When the washing appliance is not experiencing any filling problems (i.e., was filled sufficiently to cause first float switch 26 to be in contact with terminal 26b), the change from state 3 to state 4 has no effect due to first float switch 26 already preventing power from being supplied to first timer switch 36.

After a predetermined time period, as dictated by timer motor 34, control system 20 switches from state 4 to state 5, as shown in FIG. 6A. State 5 corresponds to checking for a no-fill condition. In state 5, timer motor 34 causes second timer switch 38 to switch from being in contact with terminal 38a to being in contact with terminal 38b. Under normal operation of the washing appliance (i.e., first float switch 26 being in contact with terminal 26b), the switch from state 4 to state 5 has no effect. Timer motor 34 continues to receive power via timer motor bypass circuit 48 due to second pair of contacts 46 being closed.

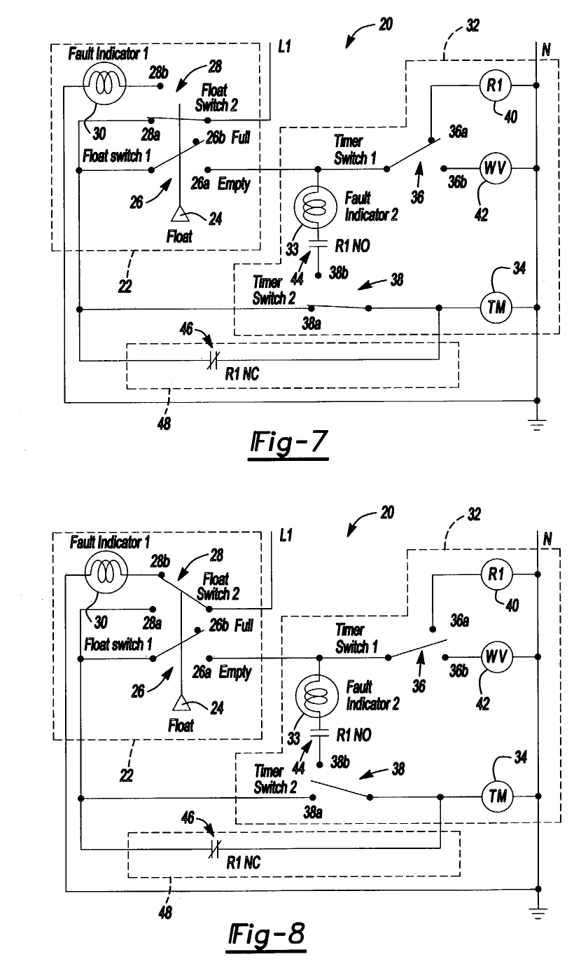

After another predetermined time period, as dictated by timer motor 34, control system 20 switches from state 5 to state 6, as shown in FIG. 7. State 6 corresponds to allowing the washing appliance to perform its intended function with a full liquid level. When switching from state 5 to state 6, timer motor 34 causes second timer switch 38 to switch from being in contact with terminal 38b to being in contact with terminal 38a. If the washing appliance is functioning normally (i.e., no filling problems), the switch from state 5 to state 6 has no effect.

Finally, the washing appliance in which control system 20 is utilized finishes with the liquid and allows it to drain out. The draining of the liquid from the washing appliance causes float 24 to move with a change in the liquid level which in turn causes first float switch 26 to move from being in contact with terminal 26b to being in contact with terminal 26a. The movement of float 24 and first float switch 26 completes the cycle and returns control system 20 back to state 1, as shown in FIG. 2.

Thus, during normal operation of the washing appliance in which control system 20 is employed, control system 20 provides a means to supply water through water valve 42 to the washing appliance without interrupting the washing cycle. As described below, however, when an error in the filling of the washing appliance occurs (i.e., a no-fill condition or an overfill condition), control system 20 will energize one of the fault indicators 30 and 33, to alert a user of an error occurring in the washing appliance, and suspend operation of the washing appliance.

Control system 20 monitors the filling of the washing appliance with liquid through water valve 42 to detect a no-fill condition. That is, control system 20 detects when the washing appliance is not filled with liquid after a sufficient time period to allow the washing appliance to be filled to the FULL level. The detection of the no-fill condition by control system 20 causes fault indicator 33 to energize which suspends operation of timer motor 34 (i.e., sufficiently reduces a voltage drop across timer motor 34 to cause it to cease operation) which suspends operation of the washing appliance to prevent damage. Specifically, control system 20 detects a no-fill condition when the control system 20 is advanced to state 5 and the washing appliance has not been filled to the predetermined FULL level.

The detection of the no-fill condition begins during the filling cycle of state 2 when first float switch 26 fails to move from contact with terminal 26a to contact with terminal 26b. The failure of first float switch 26 to move from an empty to a FULL indication causes control system 20 to remain at state 2, as shown in FIG. 3, instead of advancing to state 3 (shown in FIG. 4). Then, when control system 20 advances to state 4, as shown in FIG. 5B, timer motor 34 causes first timer switch 36 to move from contact with terminal 36b to contact with terminal 36a, as previously discussed. Because first float switch 26 has not interrupted power to first timer switch 36, movement of first timer switch 36 de-energizes water valve 42 and energizes relay 40. The de-energizing of water valve 42 stops the addition of water to the washing appliance since the addition was not stopped by first float switch 26 moving to the FULL position. The energizing of relay 40 causes first pair of contacts 44 to close and second pair of contacts 46 to open. Timer motor 34 is still provided with power via second timer switch 38 which is in contact with terminal 38a.

When control system 20, after the predetermined time period as controlled by motor timer 34, moves from state 4, as shown in FIG. 5B, to state 5, as shown in FIG. 6B, the failure of the washing appliance to fill with water will be detected, first fault indicator 33 energized and timer motor 34 shut down. Specifically, as control system 20 switches from state 4 to state 5, second timer switch 38 moves from being in contact with terminal 38a to being in contact with terminal 38b, as discussed above. With the washing appliance experiencing a no-fill condition (i.e., first float switch 26 is in contact with terminal 26a and not terminal 26b), movement of second timer switch 38 effects control system 20. Movement of second timer switch 38 to be in contact with terminal 38b causes first fault indicator 33 to be in series with timer switch 38 which allows power to flow through first float switch 26, through fault indicator 33, through first pair of contacts 44 (which are closed because relay 40 is energized), through second timer switch 38, through timer motor 34, and to neutral line N. Thus, fault indicator 33 will sound an alarm (either visually or audibly). Additionally, because timer motor 34 only receives power through first fault indicator 33, due to relay 40 being energized which causes second pair of contacts 46 to be open, timer motor 34 is shut down. Specifically, fault indicator 33 is designed to have a voltage drop that is sufficient to cause the voltage seen by timer motor 34 to be insufficient to operate timer motor 34, as is known in the appliance control art. The suspension of operation of timer motor 34 interrupts operation of the washing appliance. Therefore, control system 20 provides a user of the washing appliance with an indication of a no-fill condition occurring and suspends operation of the washing appliance so that damage to the washing appliance is minimized and/or prevented during a no-fill condition.

Control system 20 is also capable of detecting and indicating an overfill condition (i.e., a liquid level in the washing appliance of a predetermined overfill level) in the filling of the washing appliance with liquid via float 24 and second float switch 28. That is, second float switch 28 is responsive to movement of float 24 such that if float 24 continues to move beyond the predetermined FULL level to a predetermined overfill level, as shown in FIG. 8, second float switch 28 moves from being in contact with terminal 28a to being in contact with terminal 28b. Movement of second float switch 28 to being in contact with terminal 28b interrupts the supply of power to sequence control circuit 32 and sequence controller bypass circuit 48 so that liquid flow through water valve 42, operation of the timer motor 34, and operation of the washing appliance is suspended. Water valve 42 cannot be energized when second float switch 28 is in contact with terminal 28b and additional water cannot be added to the washing appliance during an overfill condition. Additionally, movement of second float switch 28 to being in contact with terminal 28b energizes first fault indicator 30, which provides a visual and/or audible alarm to indicate that an error has occurred and the washing appliance has been overfilled with liquid. Control system 20 is able to energize first fault indicator 30 and suspend operation of the washing appliance regardless of the positions of first and second timer switches 36 and 38. Thus, control system 20 is capable of suspending operation of the washing appliance and indicating an overfill condition when the washing appliance has been overfilled with liquid.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A control system for a washing appliance comprising:
a fault indicator operable to signal occurrence of a fault when energized; and
a sequence controller controlling a portion of operation of said washing appliance, said sequence controller being operable to energize said fault indicator when a no-fill condition occurs in said washing appliance.

2. The control system of claim 1, further comprising a level sensor responsive to a liquid level in said washing appliance, said level sensor operating in conjunction with said sequence controller to energize said fault indicator when said no-fill condition occurs.

3. The control system of claim 2, wherein said level sensor causes a cessation in a filling cycle of said appliance when a predetermined liquid level is detected in said washing appliance.

4. The control system of claim 3, wherein said level sensor is a float assembly that operates a float switch, said float switch preventing energization of a liquid fill device when said float assembly detects said predetermined liquid level in said washing appliance.

5. The control system of claim 2, wherein said level sensor is operable to detect an overfill condition in said washing appliance and interrupts power when said overfill condition is detected.

6. The control system of claim 5, wherein said level causes energization of a second fault indicator when said overfill condition is detected.

7. The control system of claim 1, wherein operation of said sequence controller is suspended when said no-fill condition is detected.

8. The control system of claim 7, wherein suspension of operation of said sequence controller suspends operation of said washing appliance.

9. The control system of claim 1, further comprising a liquid fill device through which a liquid is added to said washing appliance and wherein said sequence controller controls a switch that is operable between allowing energization of said liquid fill device and preventing energization of said liquid fill device.

10. The control system of claim 1, wherein said sequence controller controls a switch that is operable between allowing energization of said fault indicator and preventing energization of said fault indicator.

11. A control system for a washing appliance comprising:
a liquid fill device operable to selectively allow a liquid to flow into a washing appliance;
a fault indicator operable to signal occurrence of a no-fill condition when energized;
a level sensor responsive to a level of said liquid in said washing appliance;
a level switch responsive to said level sensor, said level switch having a first position corresponding to a first predetermined liquid level in said washing appliance and a second position corresponding to a second predetermined liquid level in said washing appliance, said second predetermined liquid level being greater than said first predetermined liquid level; and
a sequence controller operable to control energization of said fault indicator when said level switch is in said first position and energizing said fault indicator when a no-fill condition occurs.

12. The control system of claim 11, wherein said level switch is a first level switch and further comprising a second level switch responsive to said level of said liquid in said washing appliance, said second level switch interrupting power to said sequence controller and suspending operation of said washing appliance when an overfill condition occurs in said washing appliance.

13. The control system of claim 12, wherein said fault indicator is a first fault indicator and further comprising a second fault indicator operable to signal occurrence of an overfill condition when energized, said second fault indicator being energized by said second level switch when an overfill condition occurs.

14. The control system of claim 12, wherein said second level switch is responsive to said level sensor.

15. The control system of claim 11, further comprising a relay having first and second pairs of contacts, said first pair of contacts being open when said relay is not energized and closed when said relay is energized, and said second pair of contacts being closed when said relay is not energized and open when said relay is energized, and wherein:
said fault indicator is in series with said first pair of contacts;
said first position of said level switch energizes at least one of said relay, said liquid fill device and said fault indicator, and said second position of said level switch prevents energization of said relay and said liquid fill device; and
said sequence controller is operable to control energization of said relay and said liquid fill device when said level switch is in said first position.

16. The control system of claim 15, wherein said sequence controller operates first and second sequence switches, and when said level switch is in said first position said first sequence switch is operable to control energization of said relay and said liquid fill device and said second sequence switch is operable to allow energization of said fault indicator.

17. The control system of claim 11, wherein said second position of said level switch prevents energization of said fault indicator.

18. The control system of claim 11, wherein said level sensor is a float and said level sensor switch is a float switch coupled to said float.

19. The control system of claim 11, wherein said sequence controller is a timer motor.

20. A method of operating a washing appliance comprising the steps of:
(a) monitoring a liquid level in a washing appliance during a fill cycle of said washing appliance; and
(b) signaling a fault condition when a no-fill condition occurs in said washing appliance.

21. The method of claim 20, further comprising the step of (c) signaling a fault condition when an overfill condition occurs in said washing appliance.

22. The method of claim 21, wherein step (c) further comprises energizing a fault indicator when said overfill condition occurs.

23. The method of claim 21, further comprising the step of (d) suspending operation of a sequence controller that controls the filling cycle of said washing appliance when said overfill condition occurs.

24. The method of claim 21, further comprising the step of (d) suspending operation of said washing appliance when said overfill condition occurs.

25. The method of claim 20, wherein step (b) further comprises energizing a fault indicator when said no-fill condition occurs.

26. The method of claim 20, further comprising the step of (c) suspending operation of a sequence controller that controls the filling cycle of said washing appliance when said no-fill condition occurs.

27. The method of claim 20, further comprising the step of (c) suspending operation of said washing appliance when said no-fill condition occurs.

28. The method of claim 20, wherein step (a) includes monitoring said liquid level with a float.
